(19) United States
(12) Patent Application Publication
(10) Pub. No.: US 2017/0278330 A1
(43) Pub. Date: Sep. 28, 2017

(54) METHOD AND APPARATUS FOR WIRELESS VEHICULAR ACCESS DEVICE AUTHENTICATION

(71) Applicant: FORD GLOBAL TECHNOLOGIES, LLC, Dearborn, MI (US)

(72) Inventors: Pietro BUTTOLO, Dearborn Heights, MI (US); James Stewart RANKIN, II, Novi, MI (US); Stephen Ronald TOKISH, Sylvania, OH (US); Stuart C. SALTER, White Lake, MI (US)

(21) Appl. No.: 15/076,978

(22) Filed: Mar. 22, 2016

(51) Int. Cl. G07C 9/00

(52) U.S. Cl. CPC G07C 9/00119

(57) ABSTRACT

A computer-implemented method includes receiving a request from a mobile device to activate a recognition sequence. The method also includes transmitting a plurality of time-stamped recognition codes to the device, responsive to the request. The method further includes receiving an acknowledgement following transmission of a proper recognition code. The method also includes calculating a time-delay between transmission of the proper recognition code and acknowledgement receipt. The method additionally includes receiving a key-code from the device and comparing the key-code to a code exchanged with the device when the device was previously present within a vehicle. Further, the method includes measuring the received strength of multiple wireless signals successively received from the device and conditional on the time-delay being below a predefined threshold, verification of the key-code and the received signal strength of multiple wireless signals matching a predefined pattern of increasing signal strength, providing vehicle system access to the device.

### TECHNICAL FIELD

The illustrative embodiments generally relate to a method and apparatus for wireless vehicular access device authentication.

### BACKGROUND

As personal devices are getting “smarter” and interconnected, there is an opportunity to integrate more intelligence and sensing into vehicle interior and exterior components. Existing plug-and-play architecture combined with the capability of locating personal devices inside the vehicle allow for some very powerful interaction user experiences, such as enhanced implementation of keyless entry.

Keyless entry systems are becoming commonplace among automotive OEMs and after-market manufacturers. As the driver, or someone in possession of the key-fob, approaches the vehicle and gets sufficiently close, a short range signal from the key-fob automatically unlocks the door without the need of pressing any button. Other solutions additionally propose the automated locking-unlocking of vehicle doors, lift-gate and trunk lid as the driver leaves or approaches the vehicle. These solutions rely on a mix of technologies, ranging from the traditional key-fob, to the use of proximity sensors or personal devices.

Existing methods for lock and unlock of vehicle doors are susceptible to relay attacks. Relay attacks, also known as man-in-the-middle, are particularly hard to prevent, since they can bypass any encryption by simply capturing and retransmitting the signal at both ends of the authentication process.

Keyless entry systems in which a door is unlocked as a user in possession of a key-fob approaches a vehicle are well known and commonplace in today's automotive sector. Also widespread are systems to allow the opening of a vehicle trunk or lift-gate by simultaneous detection of the key-fob and a specific gesture, such as waving a foot in proximity of a sensor underneath the rear bumper. Solutions implementing an array of capacitive sensors that require the user to just walk and stop in front of the lift-gate, without the need to “kick” or “gesture” have also been proposed.

Some of the proposed methods additionally describe how the lift-gate or trunk lid would also automatically be closed as the user leaves the area. An even more inclusive concept proposes a combination of visual, proximity and radiofrequency location tracking to recognize the motion pattern of somebody approaching and stopping in front of the lift-gate of a vehicle. If that person is also in possession of a key-fob the gate is automatically opened. Quite a few methods have also been disclosed that make use of personal devices to authenticate the user and automatically unlock/lock doors on approach and departure. Most of these methods use Bluetooth Smart or similar wireless technologies to detect proximity and in some cases, route of approach to the vehicle.

There are, however, some limitations with these solutions. Some methods will only work in association with a key-fob. Some methods, like most of the capacitive implementations, will close the gate as the user leaves the back of the vehicle: in a scenario in which objects are transferred from, let's say the passenger seat, into the trunk, this would result in the lid opening and closing multiple times as the user shuffles between the front and the back of the vehicle. All these methods are also driver centric and do not scale well when multiple occupants are traveling together, but most importantly, they are also intrinsically unsafe to snooping. A person with malicious intent can easily “break” the current keyless entry systems.

### SUMMARY

In a first illustrative embodiment, a system includes a processor configured to receive a request from a mobile device to activate a recognition sequence. The processor is also configured to transmit a plurality of time-stamped recognition codes to the device, responsive to the request. The processor is further configured to receive an acknowledgement following transmission of a proper recognition code. The processor is additionally configured to calculate a time delay between transmission of the proper recognition code and acknowledgement receipt and, conditional on the time delay being below a predefined threshold, provide vehicle system access to the device.

In a second illustrative embodiment, a system includes a mobile device having a processor configured to wirelessly transmit an access request to a vehicle having a processor based on the mobile device being within a predetermined proximity to the vehicle. The processor is also configured to request an authentication code from the vehicle. The processor is further configured to wirelessly receive a series of authentication codes from the vehicle and respond with an acknowledgment to the vehicle upon determining a proper authentication code from the series has been received.

In a third illustrative embodiment, a computer-implemented method includes receiving a request from a mobile device to activate a recognition sequence. The method also includes transmitting a plurality of time-stamped recognition codes to the device, responsive to the request. The method further includes receiving an acknowledgement following transmission of a proper recognition code. Also, the method includes calculating a time delay between transmission of the proper recognition code and acknowledgement receipt. The method additionally includes receiving a key-code from the device and comparing the key-code to a code exchanged with the device when the device was previously present within a vehicle. Further, the method includes measuring a strength of multiple wireless signals successively received from the device. Additionally, the method includes providing vehicle system access to the device, conditional on the time delay being below a predefined threshold, verification of the key-code, and the measured signal strengths of the multiple wireless signals matching a predefined pattern of increasing signal strength.

### BRIEF DESCRIPTION OF THE DRAWINGS

FIG. 1 shows an illustrative vehicle computing system;

FIG. 2 shows an illustrative process for vehicle-side device authentication; and

FIG. 3 shows an illustrative process for device-side authentication.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

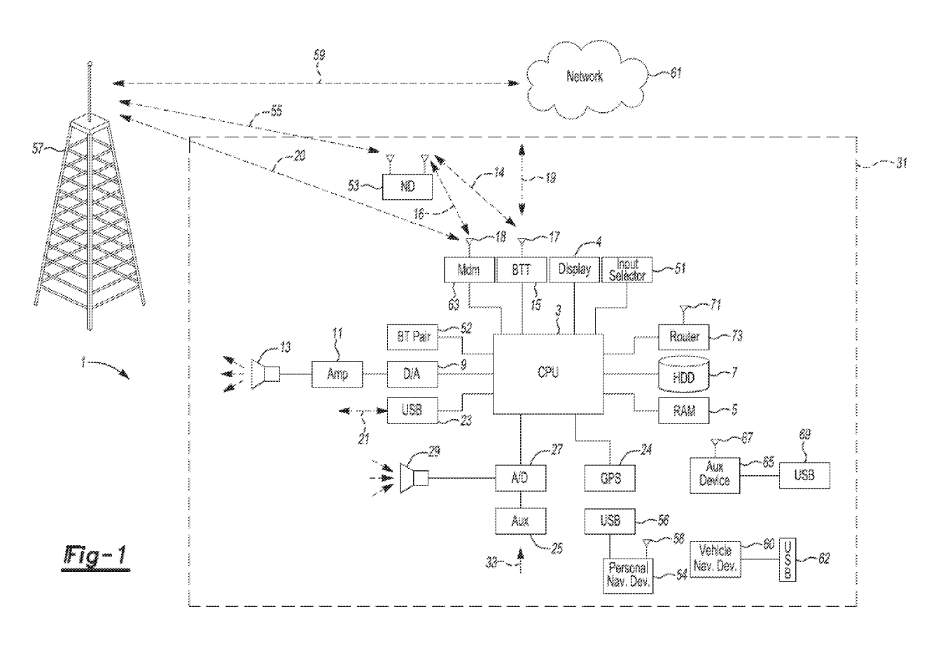

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing that portion of the process, since the wireless device would not “send and receive” information with itself. One of ordinary skill in the art will understand when it is inappropriate to apply a particular computing system to a given solution.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

The illustrative embodiments present improved remote access functionality (e.g., without limitation, lock and unlock) that utilize physical properties, strict timing and power signature. These illustrative examples and the like are much harder, if not impossible, to duplicate with a rely attack.

An illustrative framework can be used to establish a safer, more user friendly interaction paradigm for keyless entry and automatic lock-unlock of a vehicle closures, such as doors, lift-gate and trunk-lid: a one-time authentication key is exchanged each time the driver enters the vehicle and drives away. This method however can still be susceptible to relay attacks. Relays attacks, also known as man-in-the-middle, are particularly hard to prevent since they can bypass any encryption by simply capturing and retransmitting the signal at both ends of the authentication process.

The illustrative examples describe a method to securely authenticate a personal device located outside a vehicle. Safe authentication is useful to use a personal device to get access to critical function of the vehicle, such as unlocking doors, starting the engine, lowering windows and so forth (these being critical from the sense that a malicious duplication would allow access to, or even control of, the vehicle).

The illustrative embodiments leverage a method that uses on a one-time encryption key pair exchanged between a personal device and a vehicle once the personal device is recognized to be inside the vehicle in a specific seating location, and the vehicle is in motion. The system is very hard to “hack” because it relies on physical measurement of signal intensity, not on digital data packets that could be more easily counterfeited. However, even a one-time use encryption key is vulnerable to well executed relay attacks.

For example, consider a scenario in which the owner and the vehicle are in separate locations. A thief nearby the vehicle captures the communication from the vehicle and transmits it over a long range communication link to a second thief located near the owner. The second thief transmits this signal to the owner, captures the owner's personal device response, and transmits it back to the first thief. The first thief transmits it to the vehicle and the authentication is complete, without the need to break any encryption. Sometimes more than one loop of is needed between the two locations, but that doesn't remedy the gravity of the issue.

A robust way to break a relay attack is to embed in the authentication process a requirement to “match” some physical parameter beside the digital encryption. This extra physical information could be timing, signal strength, or other parameters.

An illustrative example starts with a one-time encryption code exchanged when the driver is recognized inside the vehicle. In addition to the one time code, the personal device and vehicle security module also exchange a recognition token. This exchange is safe since an RSSI signal used to detect the location of the personal device cannot be spoofed without the attempt being detected.

As the driver leaves the vehicle, the authentication method become vulnerable to man-in-middle attacks. The illustrative authentication method, however, can detect a relay attack and prevent it from completing successfully. The driver and/or police could also be warned of the failed attempt.

As a personal device gets in a short range with the vehicle, it requests the vehicle to initiate a recognition sequence. At this point the vehicle wakes from a dormant state and starts transmitting over BLE—or other communication links—a time stamped random sequence of recognition codes. This phase can be referred to as the “pin-wheel”, because of the analogy with a spinning wheel casting a different symbol with the passing of each sector. Note that the vehicle could be “spoofed” into initiating the recognition sequence by a relay attack.

The personal device scans the recognition sequence of tokens received from the vehicle, and immediately sends an acknowledgment (ACK) when the correct token matches the one-time token. The ACK message could also be captured: by a man-in-the-middle attack.

When the vehicle receives the ACK from the personal device it calculates the delay from the moment the correct token was initially sent to the receipt of the ACK. This time interval must be less than a threshold. A man-in-the-middle attack would introduce a delay that would make this condition fails, and the vehicle security module would know somebody was trying to illegally break into the system and a message could be sent to the owner and/or the police.

The one-time code automated access could be revoked and the owner required to physically pressing a button on the personal device the next time he/she needs access to the vehicle. If this phase is completed successfully, the vehicle security module sends its encryption key to the personal device. The personal device receives and matches the encryption key. If successful, the second pair of the one-time encryption key is sent to the vehicle. If all the data exchanged matches, the personal device is authenticated and given access to specific functions of the vehicle.

To make the authentication process even more robust, the signal intensity (RSSI) of messages from the personal devices to multiple modules on the vehicle could be required to match the signature pattern of somebody walking toward the vehicle. Reciprocally, the device too could use the power signature of messages sent from the module to recognize man-in-the middle attacks. The RSSI should increase as the owner with personal devices approaches the vehicle. The increase should get sharper the closer the device gets to the vehicle. The filtered signals to/from the vehicle security module could be confirmed if they satisfy the following three properties, for example:
1. The signal should be monotonically increasing on the average of the channels combined.
2. The signal should increase from threshold1 to threshold2 in less than a predetermined time interval.
3. The channel signal distribution must be either of these two patterns:
   a. Two channels on same side have consistently higher signal than two channels on opposite side; or
   b. One channel has higher signal than two adjacent channels and even larger than opposite channel (when approaching at an angle).
      These RSSI patterns conform to a mobile device approaching a vehicle, which is consistent with the notion that a driver is approaching, as opposed to a remote source trying to fake the signal.

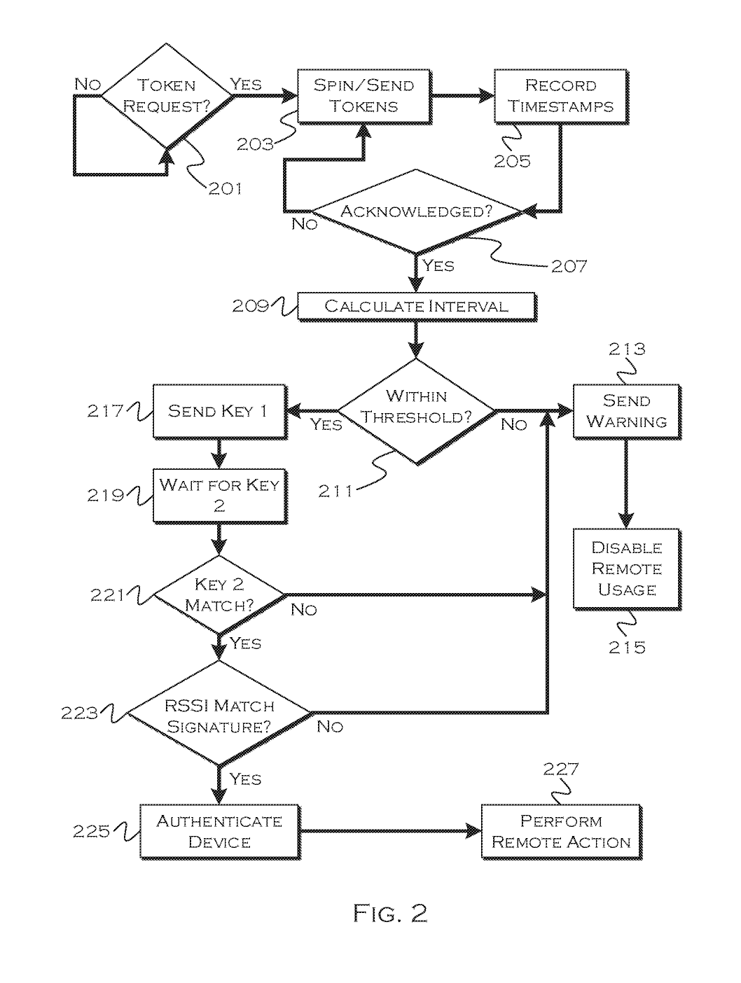

FIG. 2 shows an illustrative process for vehicle-side device authentication. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, the process begins when a driver approaches the vehicle. The vehicle may generally remain in a sleep state, to prevent battery drain from constantly searching for a driver device. But, in this example, receipt of a request from the driver device can cause the vehicle to wake to begin an authentication process. The driver device can identify its proximity to a vehicle by, for example, receipt of a vehicle identification signal or based on known vehicle GPS coordinates compared to driver device coordinates.

When the vehicle receives a token request 201, or other wake command, the authentication process can begin on the vehicle side. Once the request begins, the vehicle side process can spin out a series of tokens, sending them to the vehicle. Many of these tokens are invalid, sent for the purpose of defeating spoofing attempts. These invalid tokens will be ignored by the driver device as they are received. For each token sent, a timestamp is recorded 205. This will be used in an authentication process step described below.

Once the driver device receives a proper token, as opposed to the dummy tokens designed to foil attackers, it can send back an acknowledgement. If the vehicle receives an acknowledgement, two things can be considered. First, was the acknowledgement for the correct token. If a dummy token is acknowledged, the process can treat the acknowledgement as an attempt to maliciously access the vehicle, and, at least temporarily, disable remote access.

A more sophisticated hacker might be able to respond to the proper token, however, for example, by relaying the spun out tokens from a device near the vehicle to a device near the driver. This simulates the driver being close to the vehicle, and can cause the driver device to respond to the proper token (which is then relayed from the device near the driver to the hacker device near the vehicle, and subsequently back to the vehicle). All of this transmission, however, takes some finite period of time. There is a standard time interval during which a driver device, if actually close to the vehicle, would be able to respond to a request. If a response token sent in response to the transmitted token is incorrect 208, or if the time interval 209 for the response to the proper token is too long 211, the vehicle can send a warning 213 directly to the driver device, a monitoring service, a security service, etc. The process can also then disable remote usage of the vehicle service attempting to be accessed 215, and other services if desired. By physically unlocking the vehicle, at this point, the driver will be able to enter (or use of an override code or other non-duplicable security measure).

The process, however, uses more than the time interval and selection of correct key for authentication. The next step is to send a first key to the vehicle. This is part of a key pair exchanged when the mobile device (the driver's mobile device) was present in the vehicle. The driver device verifies the first key, and responsively sends a second key. This key is received by the vehicle 219, and verified for a match 221. If the match fails, or if the key is never received, the process can assume that a malicious attempt was made and take appropriate measures. This also may only occur if a wrong second key was received.

The key process can also be susceptible to relay attacks, by having the first key relayed to the device near the driver device, and then to the driver device, and having a responsive key (broadcast by the driver device) sent to the driver-proximate device, to the relay device near the vehicle and then to the vehicle itself.

Accordingly, a third security measure is also employed in this example, that of RSSI signal authentication. As the messages are received from a mobile device responding to the various security measures, there should be a determinable pattern of increasing message signal strength as the driver approaches the vehicle. This should range from a very low signal when the wake-up is first received, to a rapidly increasing strength as the driver approaches. Failure to recognize this increased signal can indicate that a malicious attempt is being made to access the vehicle.

If the RSSI signature matches 223, the process can proceed to authenticate the device 225 as being permitted to access a requested vehicle function. A requested action from the device can then be processed by the vehicle 227.

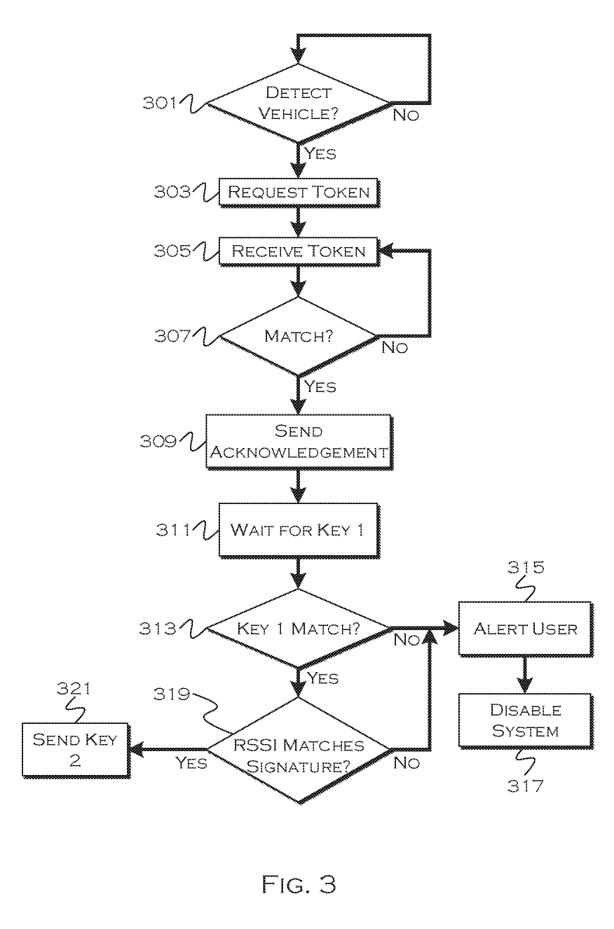

FIG. 3 shows an illustrative process for device-side authentication. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

This illustrative process represents a device-side process of the illustrative authentication procedure. As noted, the vehicle may be asleep until the device sends a signal to wake the vehicle. In this example, the device can detect the presence of a vehicle (through a low strength signal), “know” that a vehicle is nearby based on GPS coordinates, persistently broadcast a low strength wakeup signal or other suitable method of establishing vehicle communication when the device is proximate to a vehicle.

Once initial communication has been established with the vehicle 301, the process can request a token from the vehicle 303. As previously noted, in response to this request, the vehicle can spin out a number of tokens, and the device should only respond to the proper token. Variations on this theme (sending dummy data and valid data for response) are also possible. As the vehicle receives the tokens, 305, it compares each to a known, proper token, looking for a match 307.

Once the appropriate token has been matched, the process immediately sends an acknowledgement to the vehicle 309. This is the acknowledgement that the vehicle will use in conjunction with a timestamp, to determine if the request was received in an appropriate period of time.

The device then waits for a key from the vehicle 311, which will be sent if the vehicle acknowledges proper receipt of the token response. If the received key matches a key previously received by the device when the device was in the vehicle 313, the process will also check an RSSI signal strength change 319 before sending back the second key 321. This way, even if a clever hacker was slowly approaching the vehicle, while relaying signals, to simulate RSSI signal strength of the relayed signals, the driver device would not be receiving properly increasing RSSI signals (since the relayed messages will be received from the relay device, not the vehicle). Thus, the device will not send the second key, preventing the last step of authentication from occurring. This dual-sided, multi-format encryption makes it incredibly difficult, if not impossible, to use a relay attack to fake an authentication process.

The illustrative embodiments present an improved method to authenticate personal devices located outside the vehicle. This authentication is used to access to various functions, such as to allow access to a vehicle, lock/unlock doors, lift-gate and trunk lid. The method leverages the issue of a one-time access code each time a personal device is detected inside a vehicle. It prevents man-in-the-middle attacks by using 1) a timely response to a rotating token issued by the vehicle security module and 2) a transmitted power RSSI that matches the signature of somebody approaching the vehicle. Combining a physical signature with digital encryption will make the system much harder to break with both brute force and man-in-the-middle approaches.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a processor configured to:
receive a request from a mobile device to activate a recognition sequence;
responsive to the request, transmit a plurality of time-stamped recognition codes to the device;
receive an acknowledgement following transmission of a proper recognition code;
calculate a time delay between transmission of the proper recognition code and acknowledgement receipt; and
conditional on the time delay being below a predefined threshold, provide vehicle system access to the device.

2. The system of claim 1, wherein the vehicle system access includes lock/unlock functionality.

3. The system of claim 1, wherein the vehicle system access includes vehicle startup functionality.

4. The system of claim 1, wherein the processor is further configured to:
receive a key-code from the device;
compare the key-code to a code exchanged with the device when the device was previously present within a vehicle; and
further condition vehicle system access on the received key-code matching the exchanged code.

5. The system of claim 4, wherein the processor is further configured to transmit an alert if the key-code comparison fails.

6. The system of claim 1, wherein the processor is further configured to:
measure a strength of multiple wireless signals successively received from the device; and
further condition vehicle system access on an increased signal strength being measured in each consecutively received wireless signal.

7. The system of claim 6, wherein the processor is further configured to transmit an alert if increasing signal strength over consecutively received wireless signals is not measured.

8. The system of claim 6, wherein the processor is configured to further condition vehicle system access on the measured signal strength matching a predefined pattern of increasing signal strength.

9. The system of claim 1, wherein the processor is further configured to transmit an alert if the time-delay is longer than the predefined threshold.

10. The system of claim 9, wherein the processor is configured to transmit the alert to the mobile device.

11. The system of claim 9, wherein the processor is configured to transmit the alert to a monitoring service.

12. A system comprising:
a mobile device having a processor configured to:
wirelessly transmit an access request to a vehicle having a processor based on the mobile device being within a predetermined proximity to the vehicle;
request an authentication code from the vehicle;
wirelessly receive a series of authentication codes from the vehicle; and
respond with an acknowledgment to the vehicle upon determining a proper authentication code from the series has been received.

13. The system of claim 12, wherein the mobile-device processor is configured to determine that the mobile device is within the predetermined proximity based on known vehicle GPS coordinates compared to mobile device coordinates.

14. The system of claim 12, wherein the mobile-device processor is configured to determine that the mobile device is within the predetermined proximity based on receipt of a wireless indicator from the vehicle.

15. The system of claim 12, wherein the mobile-device processor is further configured to:
measure a strength of multiple wireless signals successively received from the vehicle; and
transmit a confirmation key conditioned on an increasing signal strength being measured in each consecutively received wireless signal.

16. The system of claim 15, wherein the mobile-device processor is configured to further condition transmission of the confirmation key on the measured signal strength matching a predefined pattern of increasing signal strengths.

17. The system of claim 15, wherein the confirmation key was received from the vehicle and stored on the mobile device at a previous time when the mobile device was in the vehicle.

18. The system of claim 12, wherein the proper authentication code was received from the vehicle and stored on the mobile device at a previous time when the mobile device was in the vehicle.

19. A computer-implemented method comprising:
receiving a request from a mobile device to activate a recognition sequence;
responsive to the request, transmitting a plurality of time-stamped recognition codes to the device;
receiving an acknowledgement following transmission of a proper recognition code;
calculating a time delay between transmission of the proper recognition code and acknowledgement receipt;
receiving a key-code from the device;
comparing the key-code to a code exchanged with the device when the device was previously present within a vehicle;
measuring a strength of multiple wireless signals successively received from the device; and
conditional on the time delay being below a predefined threshold, verification of the key-code, and the measured signal strengths of the multiple wireless signals matching a predefined pattern of increasing signal strength, providing vehicle system access to the device.

20. The method of claim 19, wherein the method further includes sending an alert to the mobile device if the time-delay is not below the predefined threshold, the key-code is not verified or the measured signal strengths of the multiple wireless signals does not match the predefined pattern of increasing signal strength.
